(19) United States
(12) Patent Application Publication
(10) Pub. No.: US 2014/0317428 A1
(43) Pub. Date: Oct. 23, 2014

(54) Pre-processing Operation Method and Related Electronic Device

(71) Applicant: HTC CORPORATION, Taoyuan County (TW)

(72) Inventors: Zih-Ci Lin, Taoyuan County (TW); Ruey-Jer Chang, Taoyuan County (TW); Wei-Chung Yang, Taoyuan County (TW)

(73) Assignee: HTC Corporation, Taoyuan County (TW)

(21) Appl. No.: 13/868,117

(22) Filed: Apr. 23, 2013

(51) Int. Cl. G06F 1/32

(52) U.S. Cl. CPC G06F 1/3262
USPC 713/323

(57) ABSTRACT

A pre-processing operation method for an electronic device with a touch panel, includes detecting a hovering event according a pre-processing condition of an application service; and entering into a standby mode of the application service and performing a pre-processing process after the hovering event conformed to the pre-processing condition is detected

### BACKGROUND OF THE INVENTION

1. Field of the Invention

The present invention relates to a pre-processing operation method and related electronic device, and more particularly, to a pre-processing operation method and related electronic device capable of providing smart and user-friendly operation for the user.

2. Description of the Prior Art

With the progression of science and technology, people are more closely connected to consumer electronics. People frequently use electronic devices integrated with touch sensitive function, such as smart phones, personal digital assistants (PDAs) , tablet PCs. However, conventional operation procedures of the electronic devices are either time consuming or not user-friendly. Thus, there is a need for a more efficient, user-friendly procedure for operating an electronic device with touch pad.

### SUMMARY OF THE INVENTION

It is therefore an objective of the present invention to provide a pre-processing operation method and related electronic device capable of providing smart and user-friendly operation for the user.

The present invention discloses a pre-processing operation method for an electronic device with a touch panel. The pre-processing operation method includes detecting a hovering event according a pre-processing condition of an application service; and entering into a standby mode of the application service and performing a pre-processing process after the hovering event conformed to the pre-processing condition is detected.

The present invention further discloses an electronic device.

The electronic device includes a touch panel for sensing a hovering event; a database for storing a pre-processing condition of an application services; and a processor for performing a pre-processing process according to the hovering event and the pre-processing condition.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of an electronic device according to an exemplary embodiment of the present invention.

FIG. 2 is a schematic diagram of a procedure according to an exemplary embodiment of the present invention.

FIG. 3 is a schematic diagram illustrating the relationship between application services and pre-processing conditions according to an exemplary embodiment of the present invention.

FIG. 4 is a schematic diagram illustrating an exemplary implementation of a procedure for a web surfing application service according to an exemplary embodiment of the present invention.

FIG. 5 is a schematic diagram illustrating an exemplary implementation of a procedure for an application service of zero shot lag capture function according to an exemplary embodiment of the present invention.

FIG. 6 is a schematic diagram illustrating a hovering sensing according to an exemplary embodiment of the present invention.

FIG. 7 is a schematic diagram illustrating a touch sensing according to an exemplary embodiment of the present invention.

FIG. 8 is a schematic diagram illustrating an exemplary implementation of a procedure for an application service of starting application software according to an exemplary embodiment of the present invention.

### DETAILED DESCRIPTION

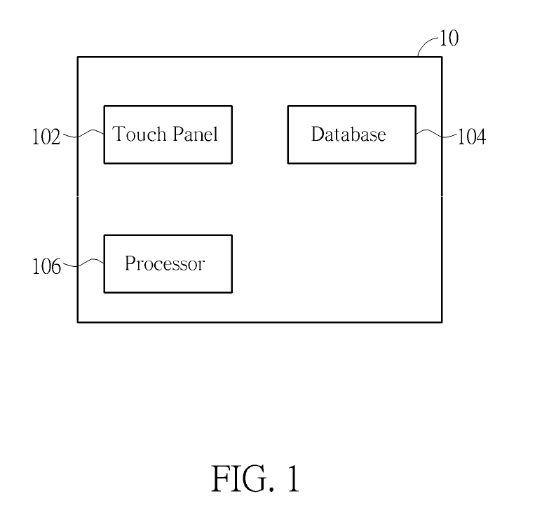

Please refer to FIG. 1, which is a schematic diagram of an electronic device 10 according to an exemplary embodiment of the present invention. As shown in FIG .1, the electronic device 10 includes a touch panel 102, a database 104 and a processor 106. The touch panel 102 is utilized for sensing hovering events. The database 104 is utilized for storing pre-processing conditions of application services. Note that the electronic device 10 may be a smart phone, a personal digital assistant (PDA) or a tablet PC, and this should not be a limitation of the present invention.

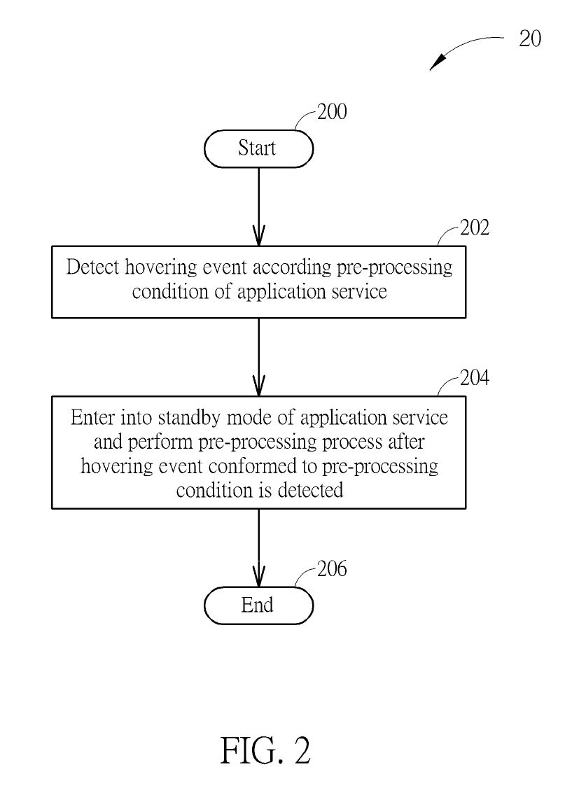

Operations of a pre-processing operation method for the electronic device 10 maybe summarized in an exemplary procedure 20. Please refer to FIG. 2, which is a schematic diagram of the procedure 20 according to an exemplary embodiment of the present invention. The procedure 20 includes the following steps:

Step 200: Start.

Step 204: Detect hovering event according pre-processing condition of application service.

Step 204: Enter into standby mode of application service and perform pre-processing process after hovering event conformed to pre-processing condition is detected.

Step 206: End.

Further description associated with the procedure 20 follows. It is assumed that the electronic device 10 can provide various application services (e.g., visiting websites, taking photos, and starting application software) for a user during operation. According to the procedure 20, in Step 202, the touch panel 102 can detect a hovering event at first. For example, while using the electronic device 10, a user may interact with the electronic device 10 for operating. When a finger of the user or a stylus pen held by the user hovers or floats above the touch panel 102, a hovering event may be sensed or detected by the touch panel 102.

Furthermore, in Step 204, after the hovering event is detected by the touch panel 102 in Step 202, the processor 106 can determine whether the hovering event sensed by the touch panel 102 conforms to a pre-processing condition stored in the database. For example, if the pre-processing condition is “hovering over a web link displayed on the touch panel 102”. Under this situation, the processor determines whether the hovering event sensed by touch panel occurs over a web link displayed on the touch panel 102. If yes, this means, the sensed hovering event is identical to the pre-processing condition stored in the database. When the hovering event conforms to the pre-processing condition, the electronic device 10 enters into a standby mode of the application service. The processor 106 further performs a pre-processing process corresponding to the application service. For example, the processor 106 connects to a website corresponding to the web link and retrieves contents of a webpage corresponding to the web link.

Moreover, the electronic device 10 can detect a triggering event of the corresponding application service. When the triggering event of the corresponding application service is detected, the electronic device 10 may enter into a normal mode of the corresponding application service. Accordingly, the processor 106 can implement the corresponding application service according to the pre-processing process. That is, the processor 106 can implement the corresponding application service by using the result of the pre-processing process during the normal mode of the corresponding application service, such that implementation of the corresponding application service can be quickly finished for fulfilling the requirements of the user. For example, when a triggering event of a web surfing application service corresponding to the above-mentioned web link, such as “touching on the web link displayed on the touch panel 102”, has been detected, the electronic device 10 may enter into a normal mode of the web surfing application service, the retrieved contents of the webpage corresponding to the web link may be displayed on the screen of the touch panel 102 for the user. Therefore, since the contents of the webpage has been pre-retrieved via the procedure 20, the electronic device 10 of the invention can rapid display the contents of webpage on the touch panel 102 and accordingly, the user can view the contents of the webpage more quickly, thus, providing more smart and user-friendly operation for the user.

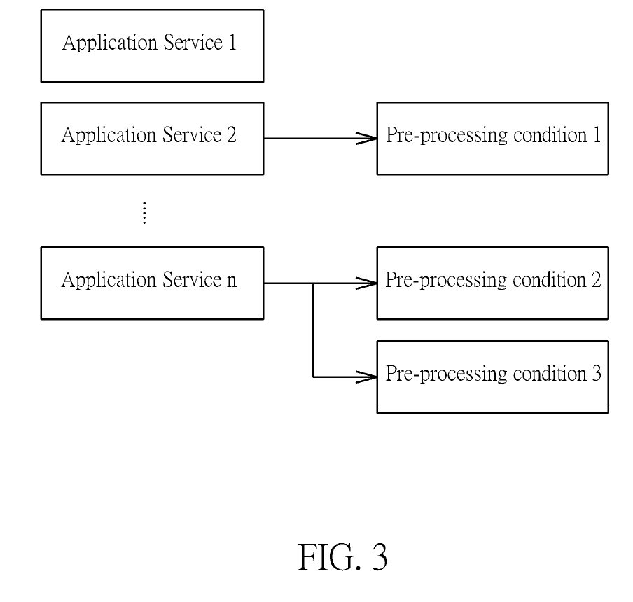

On the other hand, please refer to FIG. 3, which is a schematic diagram illustrating the relationship between application services and pre-processing conditions according to an exemplary embodiment of the present invention. The processor 106 can define the pre-processing conditions and the pre-processing process for each application service in advance. For example, as shown in FIG .3, the application service 2 is corresponding to the pre-processing condition 1 and the application service n is corresponding to the pre-processing condition 2 and the pre-processing condition 3. As such, when the hovering event meets the pre-processing condition, the processor 106 is capable of performing the corresponding pre-processing process of the application service accordingly. In addition, the pre-processing conditions can be stored into the database 104 by the processor 106.

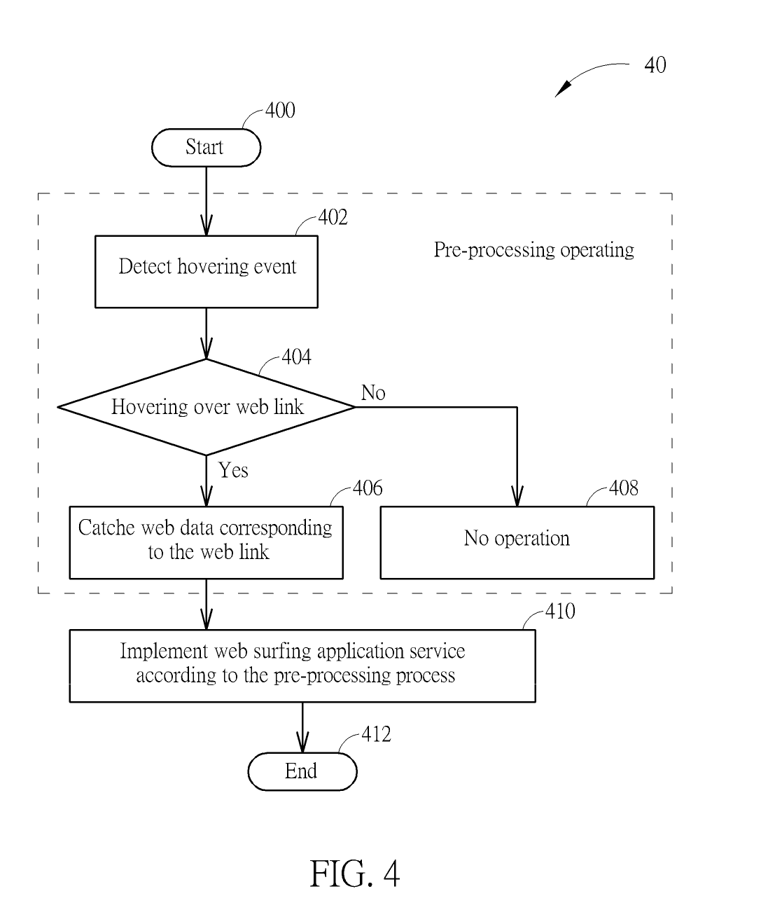

In the following, several exemplary implementations of the pre-processing operation method for the electronic device 10 shown in FIG. 1 are provided to better illustrate technical features of the present invention. Please refer to FIG. 4, which is a schematic diagram illustrating an exemplary implementation of a procedure 40 for a web surfing application service according to an exemplary embodiment of the present invention. Assume that the pre-processing condition of the web surfing application service is “hovering over a web link”. The pre-processing process is “catching web data corresponding to the web link and retrieving contents of a webpage corresponding to the web link” . The triggering event of the web surfing application service is “touching on the web link”. Under this situation, the touch panel 102 can detect a hovering event during operation of the electronic device 10 (Step 402). When a user reviews information displayed on the screen of the touch panel 102 and meanwhile, a finger of the user hovers or floats above the touch panel 102. A hovering event can be detected by the touch panel 102. After that, the processor 106 determines whether the hovering event sensed by the touch panel 102 conforms to the defined pre-processing condition. For example, the processor 106 determines whether the sensed hovering event occurs over a web link displayed on the touch panel 102 (Step 404). If the hovering event sensed by touch panel 102 does not occur over a web link displayed on the touch panel 102, the processor 106 does not perform any pre-processing operation for the web surfing application service (Step 408). If the hovering event sensed by touch panel 102 is occurred over a web link displayed on the touch panel 102, the electronic device 10 would enter into a standby mode of the web surfing application service. The processor 106 further catches the web data corresponding to the web link, i.e. the processor 106 connects to a website corresponding to the web link and retrieves contents of a webpage corresponding to the web link (Step 406).

Moreover, the electronic device 10 detects a triggering event of the corresponding application service. For example, when the finger of the user touches on the web link, a touch event can be detected by the electronic device 10 and thus, the processor 106 implements the web surfing application service corresponding to the web link according to the pre-processing process (Step 410). For example, the processor 106 can transmit the retrieved contents of the webpage to the touch panel 102. The retrieved contents of the webpage can be displayed on the touch panel 102 for the user accordingly. Therefore, since the contents of the webpage has been pre-retrieved via the procedure 40, the electronic device 10 of the invention can rapid display the contents of webpage on the touch panel 102 and accordingly, the user can view the contents of the webpage more quickly, thus, providing more smart and user-friendly operation for the user.

In aspects of user experience, when the user views some web link displayed on the screen of the touch panel 102, the user's finger may move around (but does not touch on) the position of displaying the web link, and the user may think about whether to visit the website corresponding the web link. In such a situation, via the pre-processing operation of Steps 402 to 408, the web data can be pre-cached in advance. Therefore, the pre-processing operation of Steps 402 to 408 maybe regard as a prediction of human behavior during deciding to visit the website. When the user decides to visit the website corresponding to the web link, the user would utilize his/her finger to touch on the position displayed web link so as to trigger the web surfing application service for surfing the web site corresponding to the web link. As a result, since the contents of the webpage has been pre-retrieved via the procedure 40, the contents of the web page can be rapid displayed on the touch panel 102 for the user, and thus, providing more smart and friendly operation for the user.

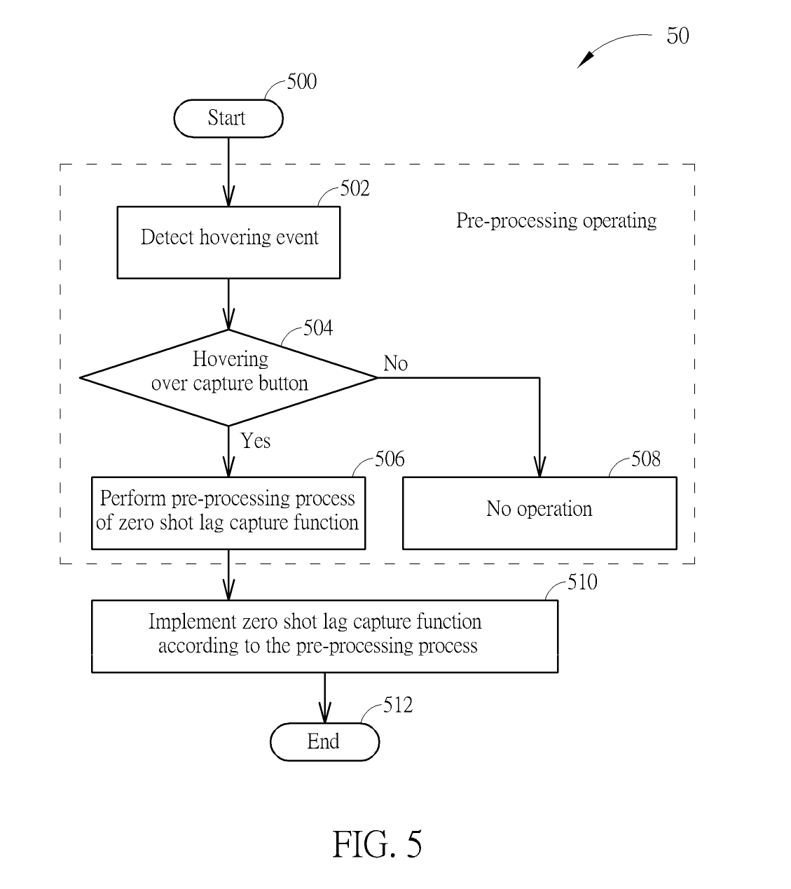

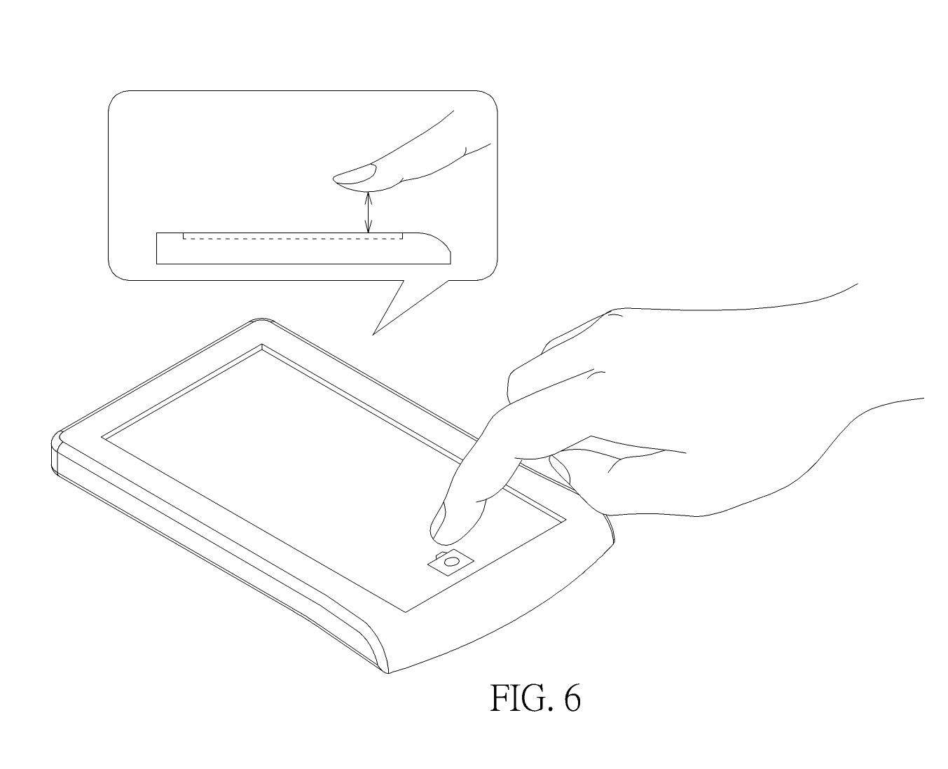

Please refer to FIG. 5, which is a schematic diagram illustrating an exemplary implementation of a procedure 50 for an application service of zero shot (shutter) lag capture function according to an exemplary embodiment of the present invention. Assume that the pre-processing condition of the application service of a zero shot lag capture function is “hovering over a capture button”. The pre-processing process is “starting capturing images and storing the captured images into a memory device”. The triggering event of the application service of the zero shot lag capture function is “touching on the capture button”. When the electronic device 10 is operated in a camera state, a capture button may be displayed on the screen of the touch panel 102. The touch panel 102 can detect a hovering event during operation of the electronic device 10 (Step 502). For example, as shown in FIG. 6, a finger of a user hovers or floats above the touch panel 102, a hovering event can be detected by the touch panel 102. After that, the processor 106 determines whether the hovering event sensed by the touch panel 102 conforms to the defied pre-processing condition. That is, the processor 106 determines whether the hovering event sensed by touch panel occurs over a capture button displayed on the touch panel 102 (Step 504). If the hovering event sensed by touch panel does not occur over the capture button, the processor 106 does not perform any operation for the web surfing application service (Step 508). If the hovering event sensed by touch panel is occurred over the capture button displayed on the touch panel 102, the electronic device 10 would enter into a standby mode of the application service of the zero shot lag capture function. The processor 106 starts performing a pre-processing process of the zero shot lag capture function (Step 506). For example, the processor 106 starts capturing images via a camera of the electronic device 10 and stores the captured images into a memory device of the electronic device 10.

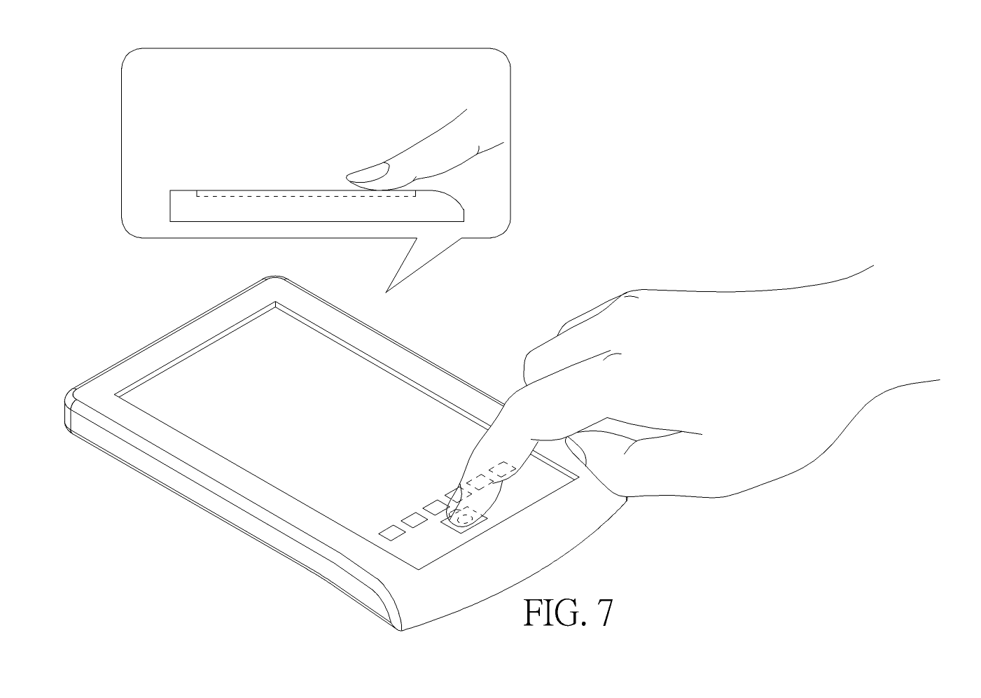

Furthermore, the electronic device 10 detects a triggering event of the corresponding application service (Step 410). For example, as shown in FIG. 7, when the finger of the user touches on the capture button, a touch event can be detected by the electronic device 10 and the electronic device 10 may enter into a normal mode of the application service of the zero shot lag capture function. The processor 106 implements the application service of the zero shot lag capture function according to the pre-processing process. For example, the processor 106 can access the captured images stored in the memory device and transmit the captured images to the touch panel 102. Thus, the captured images can be displayed on the touch panel 102 in order for preview. As a result, the user can select the required images displayed on the touch panel 102. Therefore, since the captured images buffered via the procedure 50, the electronic device 10 of the invention can rapid display the captured images on the touch panel 102 for preview, the user can view the captured images more quickly accordingly, and thus, providing more smart and user-friendly operation for the user.

In other words, if a user wants to take photos by using the application service of zero shot lag capture function and the user's finger is hovering over or floating around the capture button displayed on the touch panel 102, the electronic device 10 begins to perform the pre-processing process for capturing images and buffering the captured images. When the user touches on the capture button, the buffered images can be accessed and displayed on the touch panel 102 for preview immediately. As such, the electronic device 10 of the invention can rapid display the captured images on the touch panel 102 and the user can view the captured images more quickly, and thus, providing more smart and user-friendly operation for the user.

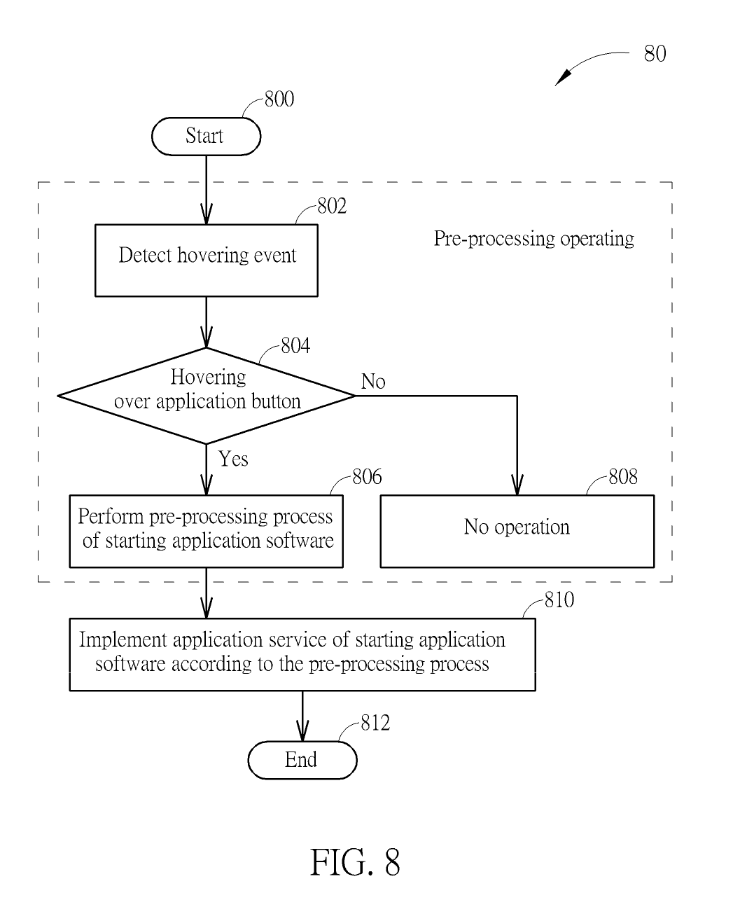

Please refer to FIG. 8, which is a schematic diagram illustrating an exemplary implementation of a procedure 80 for an application service of starting application software according to an exemplary embodiment of the present invention. Assume that the pre-processing condition of the application service is “hovering over an application icon”. The pre-processing process is “retrieving application data of a graphical user interface corresponding to the application software for rendering a corresponding graphical user interface”. The triggering event of the application service of starting application software is “double-tapping on an application icon”. Under this situation, the touch panel 102 can detect a hovering event during operation of the electronic device 10 (Step 802). When a user views an application icon displayed on the screen of the touch panel 102 and the user's finger hovers or floats above the touch panel 102, a hovering event can be detected by the touch panel 102. After that, the processor 106 determines whether the hovering event sensed by the touch panel 102 conforms to the defied pre-processing condition. That is, the processor 106 determines whether the hovering event sensed by touch panel occurs over an application icon displayed on the touch panel 102 (Step 804). If the hovering event sensed by touch panel does not occur over an application icon displayed on the touch panel 102, the processor 106 does not perform any operation for the application service of starting application software (Step 808). If the hovering event sensed by touch panel is occurred over the application icon displayed on the touch panel 102, the electronic device 10 would enter into a standby mode of starting application software. The processor 106 further retrieving application data of a graphical user interface corresponding to the application software for rendering the corresponding graphical user interface.

Moreover, the electronic device 10 detects a triggering event of the corresponding application service. When the finger of the user double taps on the corresponding application icon, a triggering event can be detected by the electronic device 10 and thus, the processor 106 implements the application service of starting the corresponding application software according to the pre-processing process (Step 810). For example, the processor 106 initializes the corresponding application software and displays the graphical user interface corresponding to the application software for the user according to the application data pre-retrieved via Steps 802 to 808. Therefore, since the application data has been pre-retrieved via the procedure 80, the electronic device 10 can rapid display the graphical user interface on the touch panel 102. The user can view the graphical user interface of the application software more quickly, and thus, providing more smart and user-friendly operation for the user.

Note that, the above-mentioned procedures are exemplary embodiments of the invention, and those skilled in the art can make alternations and modifications accordingly. For example, a hovering event (or called a floating event) may be detected via a capacitive touch sensor panel while objects hovering within the near-field of the panel and appear to be a “weak” touch. Or, a hovering event may be detected via a proximity sensor panel while objects hovering within the near-field of the panel. For example, Proximity sensors can be co-located with touch sensor of capacitive touch sensor panel to provide hover detection capabilities. These proximity sensor panels can be arranged as an array of proximity sensors that can be scanned in a manner similar to the scanning of a touch sensor panel to generate an “image” of hover.

In summary, via the pro-processing procedure of the invention based on the hovering sensitive technique, the invention can rapid finish the corresponding application service for meeting the requirements of the user, thus, providing more smart and user-friendly operation for the user.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A pre-processing operation method for an electronic device with a touch panel, comprising:
detecting a hovering event according a pre-processing condition of an application service; and
entering into a standby mode of the application service and performing a pre-processing process after the hovering event conformed to the pre-processing condition is detected.

2. The pre-processing operation method of claim 1, wherein the step of entering into the standby mode of the application service and performing the pre-processing process after the hovering event conformed to the pre-processing condition is detected comprises:
determining whether the hovering event conforms to the pre-processing condition; and
entering into the standby mode of the application service and performing the pre-processing process corresponding to the application service when the hovering event conforms to the pre-processing condition.

3. The pre-processing operation method of claim 1, further comprising:
defining the pre-processing condition and the pre-processing process for the application service.

4. The pre-processing operation method of claim 1, further comprising:
detecting a triggering event of the application service; and
entering into a normal mode of the application service and implementing the application service according to the pre-processing process after the triggering event of the application service is detected.

5. An electronic device, comprising:
a touch panel for sensing a hovering event;
a database for storing a pre-processing condition of an application services; and
a processor for performing a pre-processing process according to the hovering event and the pre-processing condition.

6. The electronic device of claim 5, wherein when the hovering event conforming to the pre-processing condition is detected, the electronic device enters into a standby mode of the application service and the processor performs the pre-processing process.

7. The electronic device of claim 6, wherein the processor determines whether the hovering event sensed by touch panel conforms to the pre-processing condition stored in the database, the electronic device enters into the standby mode of the application service, and the processor performs the pre-processing process when the processor determines that the hovering event conforms to the pre-processing condition.

8. The electronic device of claim 5, wherein the processor defines the pre-processing condition and the pre-processing process for the application service and stores the defined the pre-processing condition into the database.

9. The electronic device of claim 5, wherein when a triggering event of the application service is detected, the electronic device enters into a normal mode of the application service and the processor implements the application service according to the pre-processing process.
